(19) United States
(12) Patent Application Publication
(10) Pub. No.: US 2017/0046704 A1
(43) Pub. Date: Feb. 16, 2017

(54) Authentication Code Entry System and Method

(71) Applicant: THUMBZUP UK LIMITED, London (GB)

(72) Inventors: Willem Petrus Büchner, Raslouw, Gauteng (ZA); Leon Sybrand Lynch, Equestria, Gauteng (ZA)

(21) Appl. No.: 15/304,214

(22) PCT Filed: Dec. 23, 2014
(86) PCT No.: PCT/GB2014/053841

§ 371 Date: Oct. 14, 2016

(30) Foreign Application Priority Data
May 8, 2014 (ZA) 2014/03307

(51) Int. Cl. G06Q 20/40; G06F 3/0488; G06Q 20/08; G06Q 20/32; G06F 21/34; G06F 21/36

(52) U.S. Cl. CPC G06Q 20/4012; G06F 21/34; G06F 21/36; G06Q 20/085; G06Q 20/322; G06F 3/04883; G06F 3/04886; G06Q 2220/00

(57) ABSTRACT

An example method includes displaying, by a first computing device (110) comprising a display (114), each of one or more characters at a location of one or more locations within the display (114); receiving, by the first computing device (110) from a second computing device (150), data indicating at least one selected location of the one or more locations within the display (114); making a determination, by the first computing device (110), that at least one character of the one or more characters matches a predetermined authentication code, wherein each character of the at least one character is displayed at a location of the at least one selected location within the display (114); and after making the determination, sending, by the first computing device (110), a message authorizing a financial transaction. Corresponding operations of the second computing device (150) are disclosed herein.

### CROSS-REFERENCE TO RELATED APPLICATION

This application claims priority to South African patent application number 2014/03307, filed on May 8, 2014, entitled “A METHOD OF, AND SYSTEM FOR, ENABLING SECURE PASSWORD ENTRY USING A NON-SECURE DEVICE” which is incorporated herein by reference in its entirety.

### BACKGROUND

Unless otherwise indicated herein, the elements described in this section are not prior art to the claims and are not admitted to be prior art by inclusion in this section.

In modern society, entry of an authentication code (e.g., a personal identification number (PIN), password, or the like) is often required, for example, to gain access to a computing system or to authorise a transaction, e.g. on a Point of Sale (POS) terminal. It is known that conventional authentication code entry devices (such as keyboards, keypads, touch screens, etc.) can be compromised by rogue software (such as Trojans, viruses, spyware and the like). Data output (provided by a display screen, printers, communication interfaces, etc.) may be recorded maliciously as well (via eavesdropping, video cameras, keypad heat mapping, etc.). In this respect, it is generally known by those in the industry, that many of such input or output devices that do not provide a tamper-resistant mechanism are susceptible to data detection techniques. Devices that include such non-secure data input or output components are therefore generally known as non-secure devices. Examples of such non-secure devices may include certain personal computers, mobile phones, tablet computers, personal digital assistants, and the like.

### Overview

Example embodiments are described herein.

In one respect, an example embodiment takes the form of a method comprising displaying, by a first computing device comprising a display, each of one or more characters at a location of one or more locations within the display; receiving, by the first computing device from a second computing device, data indicating at least one selected location of the one or more locations within the display; making a determination, by the first computing device, that at least one character of the one or more displayed characters matches a predetermined authentication code, wherein each character of the at least one character is displayed at a location of the at least one selected location within the display; and after making the determination, sending, by the first computing device, a message authorizing a financial transaction.

In another respect, an example embodiment takes the form of a method comprising receiving, by a first computing device comprising a first display, input indicating one or more selected locations within the first display, wherein the one or more selected locations within the first display correspond respectively to one or more locations within a second display of a second computing device; sending, by the first computing device to the second computing device, data representing the input; receiving, by the first computing device from the second computing device, a first message indicating a match between (i) one or more characters displayed respectively at the one or more locations within the second display and (ii) a predetermined authentication code; and sending, by the first computing device to a third computing device, a second message authorizing a financial transaction.

In yet another respect, an example embodiment takes the form of a computer-readable medium storing instructions that when executed by a processor of a first computing device cause the first computing device to perform acts comprising: displaying each of one or more characters at a location of one or more locations within a display of the first computing device; receiving, from a second computing device, data indicating at least one selected location of the one or more locations within the display; making a determination, that at least one character of the one or more displayed characters matches a predetermined authentication code, wherein each character of the at least one character is displayed at a location of the at least one selected location within the display; and after making the determination, sending, a message authorizing a financial transaction.

In yet another respect, an example embodiment takes the form of a computer-readable medium storing instructions that when executed by a processor of a first computing device cause the first computing device to perform acts comprising: receiving input indicating one or more selected locations within a first display of the first computing device, wherein the one or more selected locations within the first display correspond respectively to one or more locations within a second display of a second computing device; sending, to the second computing device, data representing the input; receiving, from the second computing device, a first message indicating a match between (i) one or more characters displayed respectively at the one or more locations within the second display and (ii) a predetermined authentication code; and sending, to a third computing device, a second message authorizing a financial transaction.

In yet another respect, an example embodiment takes the form of a first computing device comprising: a processor; a display; a communication interface; and a computer-readable medium storing instructions that when executed by the processor cause the first computing device to perform acts comprising: displaying each of one or more characters at a location of one or more locations within the display; receiving, via the communication interface from a second computing device, data indicating at least one selected location of the one or more locations within the display; making a determination, that at least one character of the one or more displayed characters matches a predetermined authentication code, wherein each character of the at least one character is displayed at a location of the at least one selected location within the display; and after making the determination, sending a message authorizing a financial transaction.

In yet another respect, an example embodiment takes the form of a first computing device comprising: a processor; a first display; and a computer-readable medium storing instructions that when executed by the processor cause the first computing device to perform acts comprising: receiving input indicating one or more selected locations within the first display, wherein the one or more selected locations within the first display correspond respectively to one or more locations within a second display of a second computing device; sending, to the second computing device, data representing the input; receiving, from the second computing device, a first message indicating a match between (i) one or more characters displayed respectively at the one or more locations within the second display and (ii) a predetermined authentication code; and sending, to a third computing device, a second message authorizing a financial transaction.

These as well as other aspects and advantages will become apparent to those of ordinary skill in the art by reading the following detailed description, with reference where appropriate to the accompanying drawings. Further, it should be understood that the embodiments described in this overview and elsewhere are intended to be examples only and do not necessarily limit the scope of the invention.

### BRIEF DESCRIPTION OF THE DRAWINGS

Example embodiments are described herein with reference to the drawings, in which:

FIG. 1 illustrates an example system for authentication code entry;

FIG. 2 illustrates an example communication system;

FIG. 3 is a flow chart of an example method;

FIG. 4 illustrates example operations of a system for authentication code entry;

FIG. 5 illustrates example operations of a system for authentication code entry;

FIG. 6 illustrates example operations of a system for authentication code entry;

FIG. 7 illustrates example operations of a system for authentication code entry; and

FIG. 8 is a flow chart of an example method.

### DETAILED DESCRIPTION

### I. Introduction

This description describes, among other things, example embodiments with respect to authentication code entry. In this description, the articles “a”, “an,” or “the” are used to refer to elements of the example embodiments. The intent of using those articles is that there is one or more of the elements. The intent of using the conjunction “or” within a described list of at least 2 terms is to indicate any of the listed terms or any combination of the listed terms. The terms “first,” “second,” and “third” are used to distinguish respective elements and are not used to denote a particular order of those elements. Also, the term “one or more” is used to refer to any singular or plural amount. That is, when the term “one or more” is used, embodiments involving “two or more” and “three or more” etc. have been contemplated herein.

The following abbreviations or acronyms are used in the description:

e.g.—for example;

LCD—liquid crystal display;

mm—millimeter;

POS—point of sale;

RAM—random access memory;

ROM—read-only memory;

HTTP—hypertext transfer protocol;

FTP—file transfer protocol;

FIG.—Figure; and

FIGs.—Figures.

### II. Example Architecture

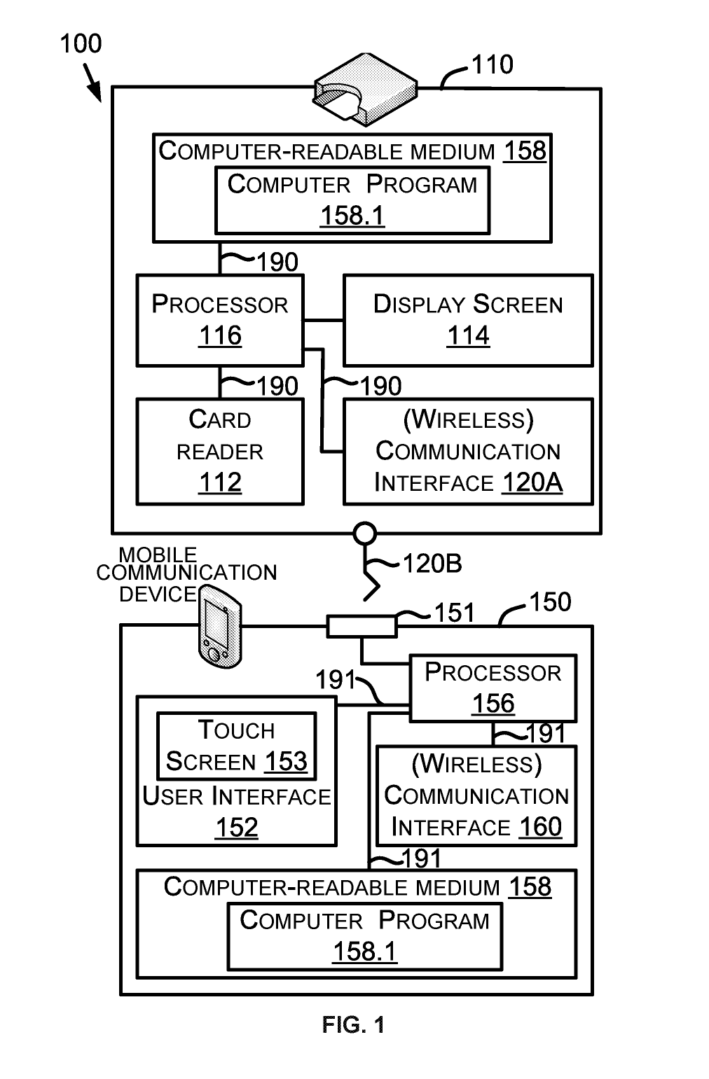

FIG. 1 illustrates a system 100 for authentication code entry. The system 100 may include a computing device 110 (e.g., a secure card reader device such as a credit/debit card reader device) and a computing device 150 (e.g., a mobile communication device such as a smart phone or a tablet). By way of example, a smart phone can include, but is not limited to, an IPHONE® smartphone from Apple Inc. of Cupertino, Calif., or a GALAXY S® smartphone from Samsung Electronics Co., Ltd. of Maetan-Dong, Yeongtong-Gu Suwon-Si, Gyeonggi-Do, Republic of Korea. By way of another example, a tablet can include, but is not limited to, an IPAD® tablet from Apple Inc., or a SAMSUNG GALAXY TAB tablet from Samsung Electronics Co., Ltd.).

The computing device 110 may include a data port (e.g., a card reader 112) which is operable to access data (e.g., an authentication code) stored on a credit/debit card that is inserted into the card reader 112. The computing device 110 may also include a display screen 114 (e.g., an LCD screen) suitable for displaying output information.

The computing device 110 also may include a processor 116 and a computer-readable medium 118 (e.g., one or more transitory, non-transitory, volatile, non-volatile, removable, or non-removable data storage medium, main memory, static memory, RAM, hard disk storage, ROM, or solid state, optical or magnetic media) having stored thereon a computer program 118.1 operable to direct the operation of the processor 116. More specifically, the processor 116 may function in certain respects as a display control module and a transaction module, according to the computer program 118.1. For example, the processor 116 may be operable to control the display screen 114 and also to receive and process data received from the computing device 150. The processor 116 may also be operable to facilitate communication with a remote banking system (e.g., a computing device or server) to authorise a financial transaction (e.g., via the wireless communication interface 120A).

The computing device 110 may include a wireless communication interface 120A and a wired communication interface 120B. The wireless communication interface 120A (e.g., a transceiver) may be configured for communication with other computing devices via a wireless communication protocol (e.g., a wireless communication standard). As an example, a wireless communication protocol can be an Institute of Electrical and Electronics Engineers (IEEE) 802.15.1 standard for wireless personal area networks (PANs) or a Bluetooth version 4.1 standard developed by the Bluetooth Special Interest Group (SIG) of Kirkland, Wash. As another example, the wireless communication protocol can be an IEEE 802.11 standard for wireless LANs, which is sometimes referred to as a Wi-Fi standard. As another example, the wireless communication protocol can be a cellular phone standard, such as standard for 3G or 4G cellular phone communications developed by the 3^{rd} Generation Partnership Project (3GPP). As another example, the wireless communication interface 120A may communicate via HTTP or FTP. Other examples of a wireless communication protocol are also possible.

The wired communication interface 120B can include a wired communication interface that is releasably connectable to another wired communication interface, such as a wired communication interface 151 of the computing device 150. Two devices, such as computing devices 110 and 150, can communicate with each other when a wired communication interface of each device are connected together. The releasable connections allows for the connected devices to be separated from one another. The wired communication interface 120B may take the form of a male 3.5 mm audio plug, or a universal serial bus (USB) male connector, but other examples are possible. It should be noted that the wired communication interface 120B may be used for transfer of data, even though the data may be transmitted via an analog signal, in accordance with conventional techniques. As another example, the wireless communication interface 120B may communicate via HTTP or FTP.

The card reader 112, the display screen 114, the computer-readable medium 118, and the wireless communication interface 120A may each be communicatively coupled to the processor 116 via a data bus 190. The data bus 190 may include any hardware (e.g., conductive wire, optical fiber, etc.) or software (e.g., communication protocols) suitable for facilitating communication between any of the elements 112, 114, 116, 118, and 120A. Although in FIG. 1 the data bus 190 is depicted as directly connecting each of the elements 112, 114, 118, and 120A with the processor 116, in other examples the data bus may provide a direct communication pathway between any of the elements 112, 114, 116, 118, and 120A.

The wired communication interface 151 of the computing device 150 can include a wired communication interface that is releasably connectable to another wired communication interface, such as the wired communication interface 120B of the computing device 110. The wired communication interface 151 may take the form of a standard female 3.5 mm audio socket (as is present in many modern mobile phones and tablets) that is configured to receive a 3.5 mm male audio plug (e.g., wired communication interface 120B) of the computing device 110. Other forms of the wired communication interface 151, such as, but not limited to, a USB female connector, are possible.

The computing device 150 further includes many aspects conventionally associated with a smart phone, including a user interface 152 that may include a touch screen 153, speakers (not shown), and/or one or more buttons, a mouse, or a keyboard (not shown). The computing device 150 also has a processor 156, a computer-readable medium 158, and wireless communication interface 160 similar to wireless communication interface 120A. As another example, the wired communication interface 151 may communicate via HTTP or FTP.

The computer-readable medium 158 (e.g., one or more transitory, non-transitory, volatile, non-volatile, removable, or non-removable data storage medium, main memory, static memory, RAM, hard disk storage, ROM, or solid state, optical or magnetic media) has stored thereon a computer program 158.1, perhaps in the form of an application which may be downloaded from a server, an online application provider (such as the APP STORE® online retail store or from the GOOGLE PLAY® online retail store), or otherwise loaded onto the computer-readable medium 158. The computer program 158.1 may be operable to facilitate data exchange with the computing device 110 via any of the communication interfaces 120A, 120B, 151, or 160. More specifically, the computer program 158.1 enables the processor 156 to cause display of a (perhaps blank) keypad or grid on a display screen (e.g., touch screen 153) of user interface 152. The processor 156 may also facilitate communication and interaction between the computing devices 110 and 150 (constituting the system 100). The processor 156 may also cause the wireless communication interface 160 to engage in communication with a remote banking system to authorise a financial transaction.

The user interface 152, the computer-readable medium 158, and the wireless communication interface 160 may each be communicatively coupled to the processor 156 via a data bus 191. The data bus 191 may include any hardware (e.g., conductive wire, optical fiber, etc.) or software (e.g., communication protocols) suitable for facilitating communication between any of the elements 152, 156, 158, and 160. Although in FIG. 1, the data bus 191 is depicted as directly connecting each of the elements 152, 158, and 160 with the processor 156, in other examples the data bus 191 may provide a direct communication pathway between any of the elements 152, 156, 158, and 160.

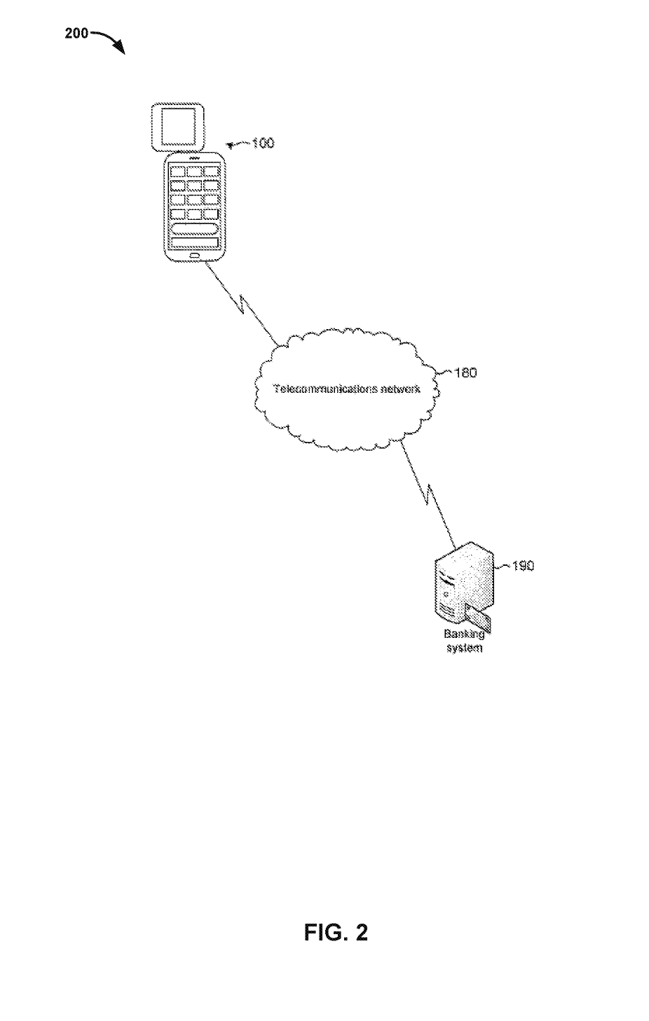

FIG. 2 illustrates an example communication system 200. The system 100 (also shown in FIG. 1) is operable to communicate via a telecommunications network 180 with a banking system 190 (which may be a payment processing system). More specifically, the computing device 110 may communicate with the banking system 190 by using the wireless communication interface 160 of the computing device 150. The banking system 190 may receive message(s) from the computing device 150 and process corresponding transactions (e.g., a purchase of a product or service by use of a credit or debit card) as though it had come from any conventional POS terminal. The banking system 190 may transmit message(s) to the computing device 110 or 150 by way of the telecommunications network 180. A message received at the computing device 110 or 150 from the banking system 190 may include an indication that the authorized financial transaction was approved, denied, or successfully performed. In accordance with a case in which an indication the financial transaction was denied, one or both of the computing device 110 and 150 can responsively display a prompt message indicating that a different card should be used to carry out the financial transaction. In accordance with a case in which an indication the financial transaction was approved or successfully performed, one of the computing devices, such as computing device, 110 or 150 can transmit a message, such as a short message service (SMS) text message or other type of electronic message to the cardholder for use as a receipt of the financial transaction.

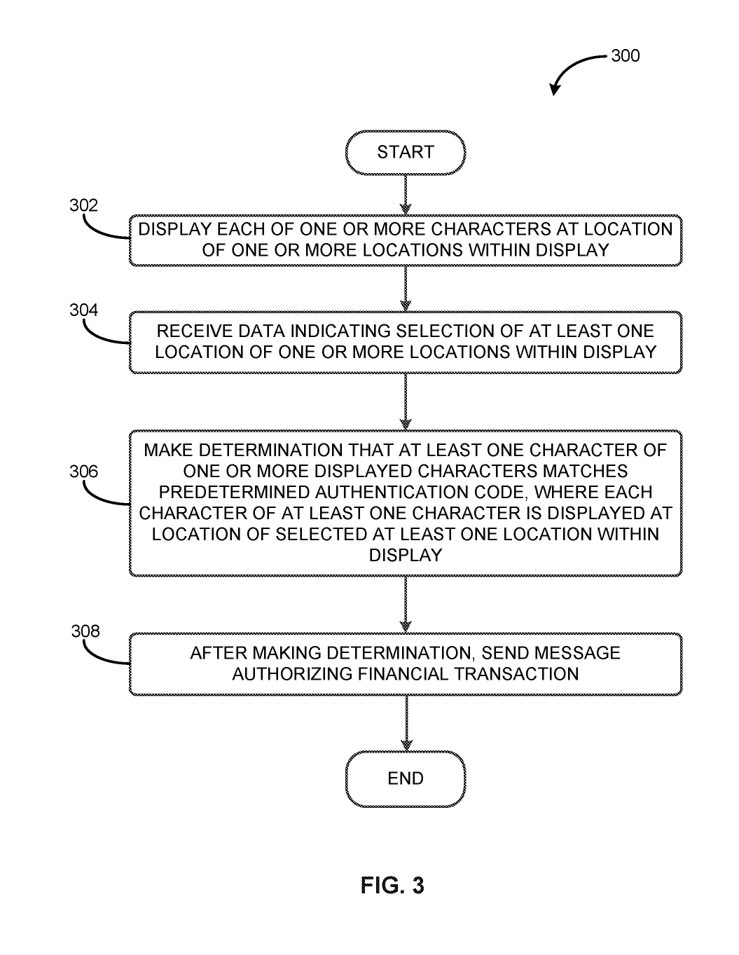

The telecommunications network 180 can include one or more different communication networks. Each of those communication networks can include, but is not limited to, the internet, a communication link of the internet, a local area network accessible by a private access point, a public access point or otherwise, a cellular telephone network, a wireless network, a wired network, or a fiber optic network. The larger device of system 100 in FIG. 2 illustrates an example of a blank keypad or grid as there are no characters within the displayed keys or grid locations. In some instances, a blank keypad or grid can include a partially blank keypad or grid, respectively, as shown in FIG. 3 to FIG. 7.

### III. Example Operations

FIG. 3 is a flow chart of an example method 300. At block 302, the method 300 involves displaying, by a first computing device comprising a display, each of one or more characters at a location of one or more locations within the display.

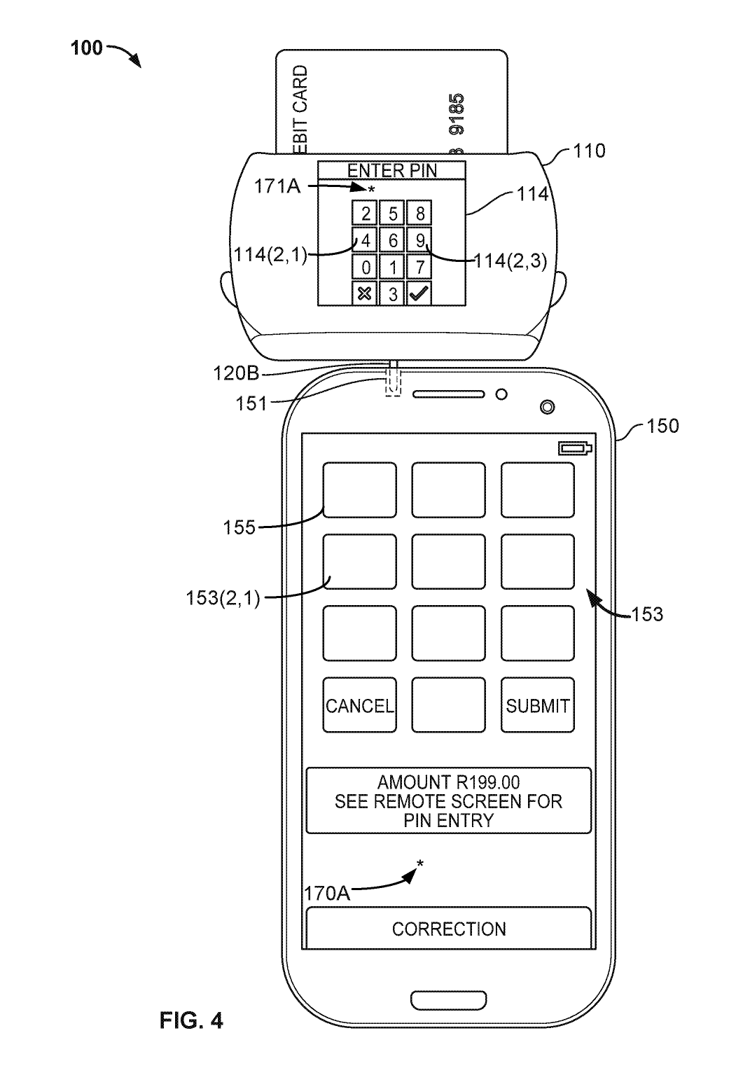

Referring to FIG. 4 for example, the computing device 110 may display the characters 0, 1, 2, 3, 4, 5, 6, 7, 8, 9, x, and a checkmark at various grid locations within the display screen 114. (In other examples, the one or more locations might not correspond to a grid pattern.) The grid locations may be identifiable by reference to row and column numbers (e.g., grid coordinates of a grid pattern) or by other location identifiers (e.g., pixel locations, or arbitrary designations).

According to a convention used herein, in FIG. 4 for example a first row of the display 114 may include the characters 2, 5, and 8, a second row of the display 114 may include the characters 4, 6, and 9, a third row of the display 114 may include the characters 0, 1, and 7, and a fourth row of the display 114 may include the characters x, 3, and a check mark. Similarly, a first column of the display 114 may include the characters 2, 4, 0, and x, a second column of the display 114 may include the characters 5, 6, 1, and 3, and a third column of the display 114 may include the characters 8, 9, 7, and the checkmark. In various examples, the one or more characters may include numerals, letters, punctuation marks, or any other type of characters.

As shown in FIG. 4, the one or more characters are mutually distinct, (e.g., no character is repeated within the one or more characters) however, this is not necessarily the case in every example. The display 114 may include a number of grid locations that is equal to a number of displayed characters, however, any non-zero number of characters or grid locations are possible. In some examples, the one or more locations of the display of the first computing device may outnumber the one or more characters displayed by the first computing device (e.g., some locations may not contain characters), or vice versa (e.g., some locations may contain multiple characters).

In various examples, the computing device 110 may randomly assign a location of the one or more locations to each of the one or more characters and then display each character of the one or more characters at the location randomly assigned to each character. (From another point of view, it may be equally accurate to say that each of the one or more characters are randomly assigned a location of the one or more locations.) As discussed below, randomization of character locations may occur once per authentication code entry, or may occur prior to entry of each character of the authentication code. In various examples, a different location may be randomly assigned to each of the one or more characters, or a single location may be randomly assigned to more than one of the one or more characters.

In some examples, the computing device 110 may be configured to display the one or more characters in response to detecting a change in state of the computing device 110. For example, the computing device 110 may detect that the wired communication interface 120B (e.g., a male audio plug) has formed a communication link with the wired communication interface 151 (e.g., a female audio socket) of the computing device 150, and may display the one or more characters in response to detecting that the communication link has been formed. Or, the computing device 110 may receive a command from the computing device 150 (e.g., upon execution of the computer program 158.1) and display the one or more characters in response to receiving the command. In some examples, the received command may simply be the receipt of data indicating a location of the one or more locations of the display 114 (or display 153) related to the selection of a character displayed by the display 114.

At block 304, the method 300 involves receiving, by the first computing device from a second computing device, data indicating at least one selected location of the one or more locations within the display. The computing device 110 may receive the data from the computing device 150 via the wired communication interfaces 151 and 120B. For example, receiving the data may include, for each of the at least one location, receiving at least one of (i) a first coordinate (e.g., a row number) and a second coordinate (e.g., a column number) that identify a location within the grid pattern and (ii) a grid position that identifies the location within the grid pattern. In another sense, the received data may include data indicating a selection of at least one location of one or more locations of the display 153, where each of the one or more locations of the display 153 correspond to a location of the display 114. One of skill in the art will understand that the difference between indicating a location of display 114 and indicating a location of display 153 will, in some cases, be a matter of semantics.

The example that follows may describe the computing device 110 receiving data, from the computing device 150, that collectively represents entry of an authentication code 4425. Within the context of FIG. 4, the received data may correspond to a touch input received by the computing device 150 at location 153(2,1) of the touch screen 153. The received touch input may correspond to the character 4 because the location 153(2,1) of the touch screen 153 may correspond to the location 114(2,1) within the display 114 of the computing device 110 (e.g., because both locations occur in a second row from the top and the first column from the left of their respective grid patterns).

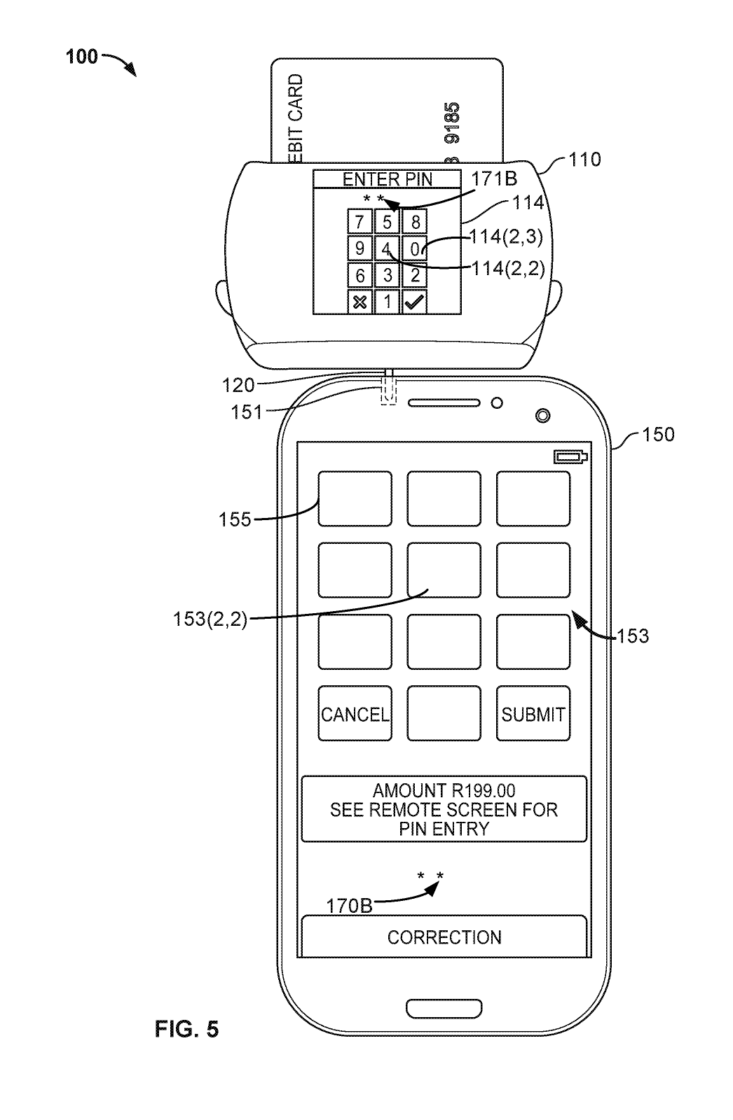

As shown in FIG. 5, additional data received by the computing device 110 may correspond to a touch input received by the computing device 150 at location 153(2,2) of the touch screen 153. The received touch input may correspond to the character 4 because the location 153(2,2) of the touch screen 153 may correspond to the location 114(2,2) within the display 114 of the computing device 110.

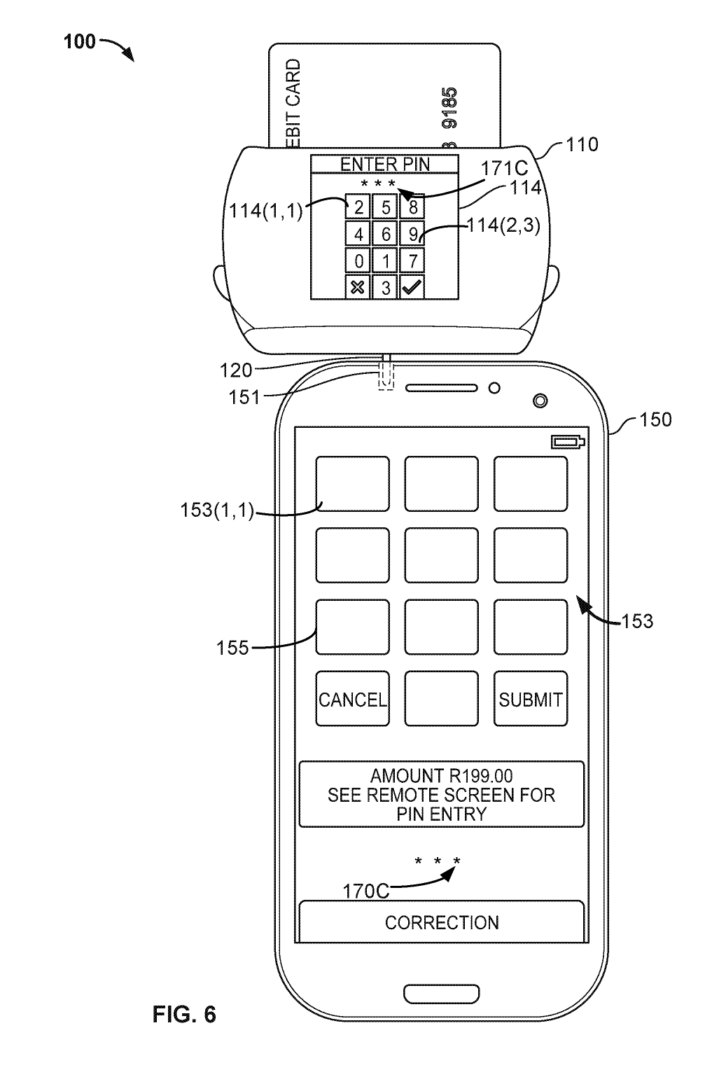

As shown in FIG. 6, further data received by the computing device 110 may correspond to a touch input received by the computing device 150 at location 153(1,1) of the touch screen 153. The received touch input may correspond to the character 2 because the location 153(1,1) of the touch screen 153 may correspond to the location 114(1,1) within the display 114 of the computing device 110.

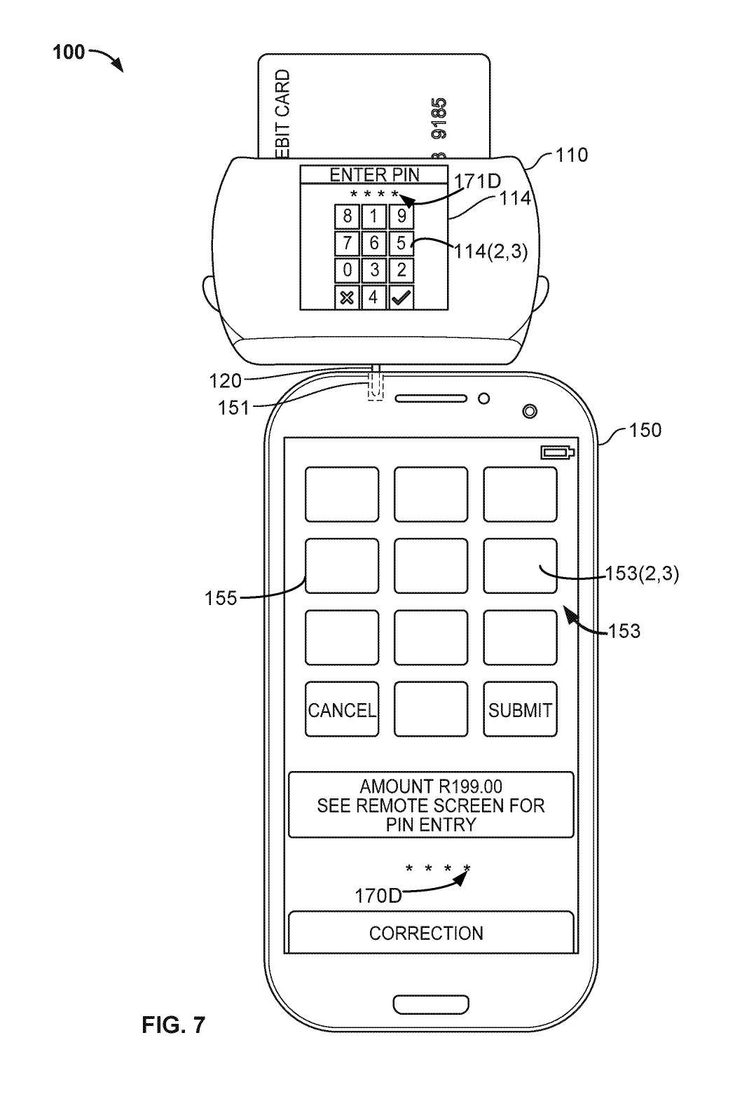

As shown in FIG. 7, yet further data received by the computing device 110 may correspond to a touch input received by the computing device 150 at location 153(2,3) of the touch screen 153. The received touch input may correspond to the character 5 because the location 153(2,3) of the touch screen 153 may correspond to the location 114(2,3) within the display 114 of the computing device 110.

The received data respectively corresponding to the characters 4425 as described above may be referred to as data packets in some contexts. That is, the computing device 110 may receive, from the computing device 150, a sequence of data packets representing selected locations of the at least one location within the display 114 or the touch screen 153. For example, the sequence of received data packets may respectively represent the of locations 153(2,1), 153(2,2), 153(1,1), and 153(2,3) (or in another sense may represent the locations 114(2,1), 114(2,2), 114(1,1), and 114(2,3)).

As shown in FIGS. 4-7, prior to receiving each data packet, the computing device 110 may randomly assign a location of the one or more locations of the display 114 to each of the one or more characters. Prior to receiving each data packet, the computing device 110 may display each of the one or more characters at the location assigned to each of the one or more characters. In this way, the locations of displayed characters may be re-randomized each time data representing an input of a grid position/character is received by the computing device 110 from the computing device 150.

Alternatively, the computing device 110 may, prior to receiving any data packet of the sequence, randomly assign a location of the one or more locations of the display 114 to each of the one or more characters. The computing device 110 may then display each of the one or more characters at the location assigned to each of the one or more characters as each data packet is received. More specifically, the computing device 110 may display the one or more characters at their respective randomly assigned locations throughout a continuous duration of time that includes the time of receiving the first data packet and the time of receiving the last data packet. That is, in some examples, the locations of the one or more characters might not be re-randomized each time data representing an input of a grid position/character is received by the computing device 110 from the computing device 150.

In some examples, the computing device 110 may also, for each received data packet, display an indication within the display 114 that the given data packet has been received. For example, in FIG. 4, an indication 171A (e.g., “*”) is shown above the grid pattern in the display 114, indicating that the data packet representing location 153(2,1), location 114(2,1) and/or character 4 has been received by the computing device 110. Likewise, in respective FIGS. 5, 6, and 7, the computing device 110 may display respective indications 171B, 171C, and 171D that the data packets representing locations 153(2,2)/114(2,2), 153(1,1)/114(1,1,), and 153(2,3)/114(2,3), and/or characters 4,2, and 5 have been received.

The data packets described herein can include one or more data elements. For example, in a simple format, a data packet may include merely an identifier of a location selected (i.e., a selected location) from the touchscreen 153. As another example, a data packet may include the selected location identifier and a character sequence number to indicate which character in an authentication code the selected location identifier pertains to. As yet another example, a data packet may include a selected location identifier, and one or more of a character sequence number, a header, a checksum, a source identifier indicating computing device 150, and a destination identifier indicating computing device 110.

At block 306, the method 300 involves making a determination, by the first computing device, that at least one character of the one or more displayed characters matches a predetermined authentication code, where each character of the at least one character is displayed at a location of the at least one selected location within the display.

For example, the computing device 110 may make a second determination that each of the characters 4, 4, 5, and 2 were respectively displayed (as the respective data packets were received) at the selected locations 114(2,1), 114(2,2), 114(1,1), and 114(2,3). The computing device 110 may then determine that the characters 4, 4, 5, and 2 representing the selected locations match the predetermined authorization code based on the second determination. The computing device 110 may store and update a state table indicating which characters are stored at each location of the display 114, to facilitate the second determination.

By further example, the computing device 110 may determine, based on the sequence of data packets (e.g., the order in which the data packets are received), a sequence of characters (e.g., 4452) that are displayed respectively at the locations represented respectively by the received data packets. The computing device 110 may then determine that the determined sequence of characters matches the predetermined authentication code (e.g., 4452) and send a message authorizing a financial transaction (see description of block 308 below) based on determining that the sequence matches the predetermined authorization code.

In another situation, the computing device 110 may receive from a storage device (e.g., a smart credit/debit card) inserted into a data port (e.g., card reader 112) of the computing device 110, data representing the predetermined authentication code. The computing device 110 may then use the data representing the predetermined authorization code to determine that the determined sequence of characters matches the predetermined authentication code. The computing device 110 may examine the contents of the storage device in response to receiving data from the computing device 150 indicating that touch input has been received at the “submit” button portion of the touchscreen 153.

At block 308, the method 300 involves after making the determination, sending, by the first computing device, a message authorizing a financial transaction. For example, the computing device 110 may send the message to the computing device 150 so that the computing device 150 may retransmit the message (or a similar message) to the banking system 190 via wireless communication interface 160 and/or the telecommunications network 180. For example, the computing device 110 may send to the computing device 150, an explicit command to send a second message, authorizing the transaction, to the banking system 190. The message transmitted by the computing device 110 to the computing device 150 and the message transmitted by the computing device 150 to the banking system 190 may both include a (possibly encrypted) transaction authorization code that the banking system 190 may recognize as authorizing a financial transaction. In some examples, the computing device 110 may send the message authorizing the financial transaction directly to the banking system 190, via the wireless communication interface 120A.

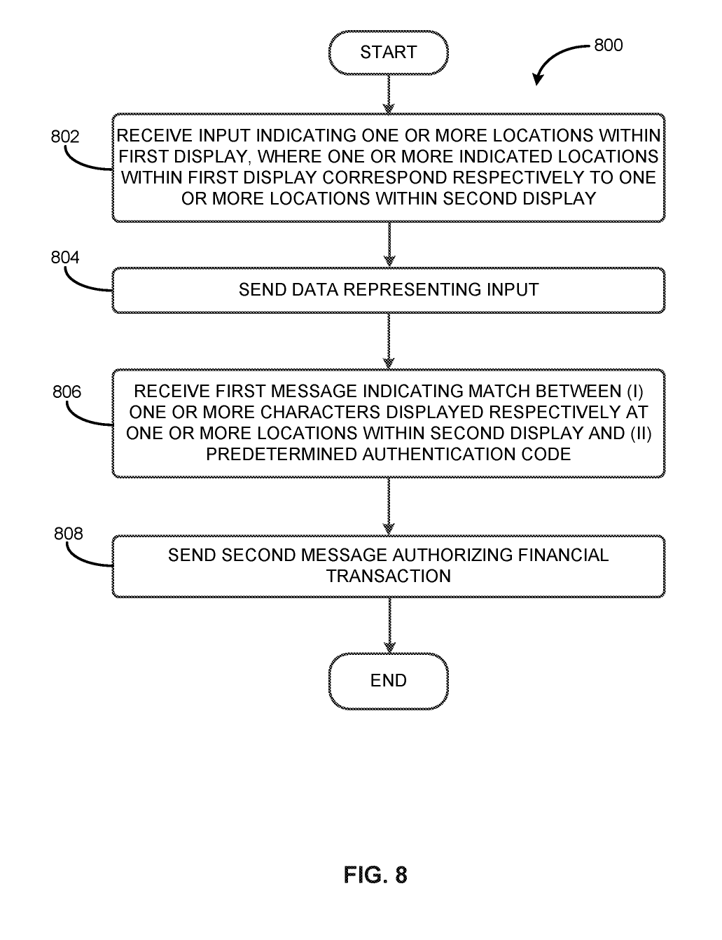

FIG. 8 is a flow chart of an example method 800. At block 802, the method 800 involves receiving, by a first computing device comprising a first display, input indicating one or more selected locations within the first display, wherein the one or more selected locations within the first display correspond respectively to one or more locations within a second display of a second computing device.

Referring to FIG. 4 for example, the computing device 150 may receive a touch input at location 153(2,1) indicating the location 153(2,1) (or equivalently the location 114(2,1)). Similarly in FIGS. 5-7 the touch screen 153 may receive touch inputs at locations 153(2,2), 153(1,1), 153(2,3), respectively indicating the location 153(2,2) (or equivalently the location 114(2,2)), the location 153(1,1) (or equivalently the location 114(1,1)), and the location 153(2,3) (or equivalently the location 114(2,3)).

The locations of the touch screen 153 may be defined by the touch screen 153 displaying one or more boundaries 155 defining the one or more locations within the touch screen 153. So, receiving the touch input at the one or more locations of the touch screen 153 may include receiving touch input at the one or more locations defined by the one or more boundaries 155. As shown in any of FIGS. 4-7, the one or more locations of the display (touch screen 153) of the computing device 150 are typically arranged in a grid pattern that corresponds to the grid pattern of the display 114 of the computing device 110.

In some examples, prior to receiving the input, the computing device 150 may send, to the computing device 110, a command to display the one or more characters (described above in relation to block 302). For example, the command may be sent by the computing device 150 when the wired communication interface 120 (e.g., male audio plug) is connected to the wired communication interface 151 (e.g., female audio socket). Or, the command may be sent by the computing device 150 upon launching of a mobile payment application (e.g., stored on computer-readable medium 158) on the computing device 150.

At block 804, the method 800 involves sending, by the first computing device to the second computing device, data representing the input. For example, the computing device 150 may send, for each of the one or more selected locations of the touch screen 153, at least one of (i) a first coordinate and a second coordinate that identify a location within the first grid pattern (of touch screen 153) and (ii) a grid position that identifies the location within the first grid pattern. For example, data (2,1) may represent location 153(2,1) by referring to the second row and the first column of the grid pattern displayed within touch screen 153. As another example, the grid positions of touch screen 153 may simply be numbered from left to right, and from top to bottom. That is, the first location from the left in the top row of touch screen 153 may be position #1, the location second from the left in the top row of touch screen 153 may be position #2, the location third from the left in the top row of touch screen 153 may be position #3, the location first from the left in the second row from the top of touch screen 153 may be position #4, etc. Any convention for identifying locations of the touch screen 153 that is recognizable by the computing device 110 may be used.

The following example may describe the computing device 150 sending data, to the computing device 110, that collectively represents entry of an authentication code 4425. Within the context of FIG. 4, the data sent to the computing device 110 may correspond to a touch input received by the computing device 150 at location 153(2,1) of the touch screen 153. The received touch input may correspond to the character 4 because the location 153(2,1) of the touch screen 153 may correspond to the location 114(2,1) within the display 114 of the computing device 110.

As shown in FIG. 5, additional data sent by the computing device 150 to the computing device 110 may correspond to a touch input received by the computing device 150 at location 153(2,2) of the touch screen 153. The received touch input may correspond to the character 4 because the location 153(2,2) of the touch screen 153 may correspond to the location 114(2,2) within the display 114 of the computing device 110.

As shown in FIG. 6, further data sent by the computing device 150 to the computing device 110 may correspond to a touch input received by the computing device 150 at location 153(1,1) of the touch screen 153. The received touch input may correspond to the character 2 because the location 153(1,1) of the touch screen 153 may correspond to the location 114(1,1) within the display 114 of the computing device 110.

As shown in FIG. 7, yet further data sent by the computing device 150 to the computing device 110 may correspond to a touch input received by the computing device 150 at location 153(2,3) of the touch screen 153. The received touch input may correspond to the character 5 because the location 153(2,3) of the touch screen 153 may correspond to the location 114(2,3) within the display 114 of the computing device 110.

At block 806, the method 800 involves receiving, by the first computing device from the second computing device, a first message indicating a match between (i) one or more characters displayed respectively at the one or more locations within the second display and (ii) a predetermined authentication code. For example, the computing device 150 may receive the message indicating the match from the computing device 110 via wired communication interfaces 120A and 151. The received message may include a command for the computing device 150 to send a second message authorizing a financial transaction to the banking system 190.

At block 808, the method 800 involves sending, by the first computing device to a third computing device, a second message authorizing a financial transaction. For example, the computing device 150 may send the second message to the banking system 190 via telecommunications network 180 and wireless communication interface 160. The message sent to the banking system 190 may include the authentication code or a transaction authorization code. The authentication code or the transaction authorization code within the message can be encrypted or can be unencrypted. The second message can include a card or account number or a cardholder name on or associated with a card releasably inserted into the card reader 112. The second message may also include an account number or other identifier of an account to receive payment and/or an amount of payment. Other examples of data within the message are also possible.

Further acts associated with the method 800 may involve sending, by the first computing device to the second computing device, a sequence of data packets representing selected locations of the one or more locations within the first display; for each sent data packet, receiving, by the first computing device from the second computing device, an indication that the sent data packet was received by the second computing device; and in response to each received indication, displaying an indication that the sent data packet corresponding to the received indication was received by the second computing device.

In FIG. 4 for example, the computing device 150 may send, to the computing device 110, a first data packet representing the location 153(2,1). In response, the computing device 110 may send, to the computing device 150, an indication that the first data packet was received by the computing device 110. Then, the computing device 150 may display the indicator 170A indicating that the first data packet was received.

Next, in FIG. 5, the computing device 150 may send, to the computing device 110, a second data packet representing the location 153(2,2). In response, the computing device 110 may send, to the computing device 150, an indication that the second data packet was received by the computing device 110. Then, the computing device 150 may display the indicator 170B indicating that the second data packet was received.

Then, in FIG. 6, the computing device 150 may send, to the computing device 110, a third data packet representing the location 153(1,1). In response, the computing device 110 may send, to the computing device 150, an indication that the third data packet was received by the computing device 110. Then, the computing device 150 may display the indicator 170C indicating that the third data packet was received.

Lastly, in FIG. 7, the computing device 150 may send, to the computing device 110, a fourth data packet representing the location 153(2,3). In response, the computing device 110 may send, to the computing device 150, an indication that the fourth data packet was received by the computing device 110. Then, the computing device 150 may display the indicator 170D indicating that the first data packet was received.

Further acts associated with the method 800 may involve receiving, by the first computing device from the second computing device, a transaction authorization code, wherein sending the second message comprises sending, by the first computing device to the third computing device, the transaction authorization code. In various examples, the transaction authorization code may be the same or different from the authentication code. For example, the computing device 150 may receive the transaction authorization code from the computing device 110, and send, to the banking system 190, a sequence of characters (e.g., the same or different from the authentication code) that the banking system 190 may recognize as authorizing a financial transaction.

### IV. Additional Example Embodiments

The following examples are offered as further description of the disclosure.

### Example 1

A method comprising: displaying, by a first computing device comprising a display, each of one or more characters at a location of one or more locations within the display; receiving, by the first computing device from a second computing device, data indicating at least one selected location of the one or more locations within the display; making a determination, by the first computing device, that at least one character of the one or more characters matches a predetermined authentication code, wherein each character of the at least one character is displayed at a location of the at least one selected location within the display; and after making the determination, sending, by the first computing device, a message authorizing a financial transaction.

### Example 2

The method of example 1, wherein the one or more characters include exactly N characters, wherein the one or more locations include exactly N locations, and wherein N is a positive integer greater than one.

### Example 3

The method of example 1, wherein the one or more characters include more than N characters, wherein the one or more locations include exactly N locations, and wherein N is a positive integer greater than one.

### Example 4

The method of any of examples 1-3, wherein the one or more locations within the display comprise one or more locations arranged in a grid pattern within the display.

### Example 5

The method of example 4, wherein receiving the data indicating the at least one selected location within the display comprises, for each of the at least one selected location, receiving at least one of (i) a first coordinate and a second coordinate that identify a location within the grid pattern and (ii) a grid position that identifies the location within the grid pattern.

### Example 6

The method of any of examples 1-5, wherein the one or more characters include at least one numeral.

### Example 7

The method of any of examples 1-6, wherein the one or more characters include at least one letter.

### Example 8

The method of any of examples 1-7, wherein the one or more characters include multiple characters that are mutually distinct.

### Example 9

The method of any of examples 1-8, wherein the determination is a first determination, the method further comprising: making a second determination, by the first computing device, that each of the at least one character is displayed at a location of the at least one selected location within the display; and making the first determination based, at least in part, on the second determination.

### Example 10

The method of any of examples 1-9, further comprising: randomly assigning a location of the one or more locations to each of the one or more characters; and displaying each character of the one or more characters at the location randomly assigned to the character.

### Example 11

The method of any of examples 1-10, wherein the display is a first display, wherein the received data indicating the at least one selected location of the one or more locations within the first display comprises data indicating at least one selected location within a second display of the second computing device, and wherein each location of the at least one selected location within the second display corresponds respectively to a location of the at least one selected location within the first display.

### Example 12

The method of any of examples 1-9 and 11, wherein receiving the data indicating the at least one selected location includes receiving, by the first computing device from the second computing device, a sequence of multiple data packets representing multiple respective location selections of the at least one selected location, and wherein the method further comprises: prior to receiving each data packet, randomly assigning, by the first computing device, a location of the one or more locations to each of the one or more characters; and prior to receiving each data packet, displaying each of the one or more characters at the location assigned to each of the one or more characters. In accordance with examples 12, 13, 31, 45, 46, 65, 80, 81, and 100, and any examples dependent therefrom, the multiple respective location selections can include location selections that are all mutually distinct or can include one or more location selections that are repeated at least one time.

### Example 13

The method of any of examples 1-9 and 11, wherein receiving the data indicating the at least one selected location includes receiving, by the first computing device from the second computing device, a sequence of multiple data packets representing multiple respective location selections of the at least one selected location, and wherein the method further comprises: prior to the first computing device receiving any data packet of the sequence, randomly assigning, by the first computing device, a location of the one or more locations to each of the one or more characters; and displaying each of the one or more characters at the location assigned to each of the one or more characters as each data packet is received. Example 14: The method of any of examples 10, 12, and 13, wherein randomly assigning a location of the one or more locations to each of the one or more characters comprises assigning a different location to each of the one or more characters.

### Example 15

The method of any of examples 12 and 13, further comprising, for each received data packet, displaying an indication, within the display of the first computing device, that the data packet has been received.

### Example 16

The method of any of examples 12 and 13, further comprising: determining by the first computing device, based on the sequence of data packets, a sequence of characters that are displayed respectively at the locations represented respectively by the received data packets; determining, by the first computing device, that the determined sequence of characters matches the predetermined authentication code; and sending the message based on determining that the sequence matches the predetermined authorization code.

### Example 17

The method of example 16, further comprising: receiving, by the first computing device from a storage device inserted into a data port of the first computing device, data representing the predetermined authentication code; and using the data representing the predetermined authorization code to determine that the determined sequence of characters matches the predetermined authentication code.

### Example 18

The method of any of examples 1-17, wherein the message authorizing the financial transaction is sent to the second computing device.

### Example 19

The method of example 18, wherein the message is a first message, and wherein sending the first message comprises sending a command, by the first computing device to the second computing device, for the second computing device to send a second message, to a third computing device, authorizing the financial transaction.

### Example 20

The method of example 19, wherein the first message and the second message both include an encrypted authorization code.

### Example 21

The method of any of examples 1-17, wherein the message authorizing the financial transaction is sent to a third computing device.

### Example 22

The method of any of examples 1-21, further comprising: detecting a change in state of the first computing device; and displaying each of the one or more characters in response to detecting the change in state.

### Example 23

The method of example 22, wherein detecting the change in state of the first computing device comprises determining that a communication link has been established between the first computing device and the second computing device.

### Example 24

The method of example 22, wherein detecting the change in state of the first computing device comprises receiving a command, from the second computing device, to display each of the one or more characters.

### Example 25

A method comprising: receiving, by a first computing device comprising a first display, input indicating one or more selected locations within the first display, wherein the one or more selected locations within the first display correspond respectively to one or more locations within a second display of a second computing device; sending, by the first computing device to the second computing device, data representing the input; receiving, by the first computing device from the second computing device, a first message indicating a match between (i) one or more characters displayed respectively at the one or more locations within the second display and (ii) a predetermined authentication code; and sending, by the first computing device to a third computing device, a second message authorizing a financial transaction.

### Example 26

The method of example 25, wherein the first display is a touch screen, and wherein receiving the input indicating the one or more selected locations within the first display comprises receiving touch input at the one or more selected locations of the touch screen.

### Example 27

The method of example 26, further comprising: displaying one or more boundaries defining the one or more locations within the touch screen; and wherein receiving the touch input at the one or more selected locations of the touch screen comprises receiving touch input at the one or more locations defined by the one or more boundaries.

### Example 28

The method of any of examples 25-27, wherein the one or more locations within the first display comprise one or more locations arranged in a first grid pattern within the first display, and wherein the one or more locations within the second display comprise one or more locations arranged in a second grid pattern within the second display.

### Example 29

The method of example 28, wherein sending the data representing the input comprises, for each of the one or more selected locations within the first display, sending at least one of (i) a first coordinate and a second coordinate that identify a location within the first grid pattern and (ii) a grid position that identifies the location within the first grid pattern.

### Example 30

The method of example 28, wherein sending the data representing the input comprises, for each of the one or more selected locations within the first display, sending at least one of (i) a first coordinate and a second coordinate that identify a location within the second grid pattern and (ii) a grid position that identifies the location within the second grid pattern.

### Example 31

The method of any of examples 25-30, further comprising: sending, by the first computing device to the second computing device, a sequence of multiple data packets representing multiple respective location selections of the one or more selected locations within the first display; for each sent data packet, receiving, by the first computing device from the second computing device, an indication that the sent data packet was received by the second computing device; and in response to each received indication, displaying an indication that the sent data packet corresponding to the received indication was received by the second computing device.

### Example 32

The method of any of examples 25-31, further comprising: receiving, by the first computing device from the second computing device, a transaction authorization code, wherein sending the second message comprises sending, by the first computing device to the third computing device, the transaction authorization code.

### Example 33

The method of any of examples 25-32, further comprising, prior to receiving the input, sending, to the second computing device, a command to display the one or more characters.

### Example 34

A computer-readable medium storing instructions that when executed by a processor of a first computing device cause the first computing device to perform acts comprising: displaying each of one or more characters at a location of one or more locations within a display of the first computing device; receiving, from a second computing device, data indicating at least one selected location of the one or more locations within the display; making a determination, that at least one character of the one or more characters matches a predetermined authentication code, wherein each character of the at least one character is displayed at a location of the at least one selected location within the display; and after making the determination, sending, a message authorizing a financial transaction.

### Example 35

The computer-readable medium of example 34, wherein the one or more characters include exactly N characters, wherein the one or more locations include exactly N locations, and wherein N is a positive integer greater than one.

### Example 36

The computer-readable medium of example 34, wherein the one or more characters include more than N characters, wherein the one or more locations include exactly N locations, and wherein N is a positive integer greater than one.

### Example 37

The computer-readable medium of any of examples 34-36, wherein the one or more locations within the display comprise one or more locations arranged in a grid pattern within the display.

### Example 38

The computer-readable medium of example 37, wherein receiving the data indicating the at least one selected location within the display comprises, for each of the at least one selected location, receiving at least one of (i) a first coordinate and a second coordinate that identify a location within the grid pattern and (ii) a grid position that identifies the location within the grid pattern.

### Example 39

The computer-readable medium of any of examples 34-38, wherein the one or more characters include at least one numeral.

### Example 40

The computer-readable medium of any of examples 34-39, wherein the one or more characters include at least one letter.

### Example 41

The computer-readable medium of any of examples 34-40, wherein the one or more characters include multiple characters that are mutually distinct.

### Example 42

The computer-readable medium of any of examples 34-41, wherein the determination is a first determination, the acts further comprising: making a second determination that each of the at least one character is displayed at a location of the selected at least one location within the display; and making the first determination based, at least in part, on the second determination.

### Example 43

The computer-readable medium of any of examples 34-42, the acts further comprising: randomly assigning a location of the one or more locations to each of the one or more characters; and displaying each character of the one or more characters at the location randomly assigned to the character.

### Example 44

The computer-readable medium of any of examples 34-43, wherein the display is a first display, wherein the received data indicating the at least one selected location of the one or more locations within the first display comprises data indicating at least one selected location within a second display of the second computing device, and wherein each location of the at least one selected location within the second display corresponds respectively to a location of the at least one selected location within the first display.

### Example 45

The computer-readable medium of any of examples 34-42 and 44, wherein receiving the data indicating the at least one selected location includes receiving, from the second computing device, a sequence of multiple data packets representing multiple respective location selections of the at least one selected location, and wherein the acts further comprise: prior to receiving each data packet, randomly assigning a location of the one or more locations to each of the one or more characters; and prior to receiving each data packet, displaying each of the one or more characters at the location assigned to each of the one or more characters.

### Example 46

The computer-readable medium of any of examples 34-42 and 44, wherein receiving the data indicating the at least one selected location includes receiving, from the second computing device, a sequence of multiple data packets representing multiple respective location selections of the at least one selected location, and wherein the acts further comprise: prior to receiving any data packet of the sequence, randomly assigning a location of the one or more locations to each of the one or more characters; and displaying each of the one or more characters at the location assigned to each of the one or more characters as each data packet is received.

### Example 47

The computer-readable medium of any of examples 43, 45, and 46, wherein randomly assigning a location of the one or more locations to each of the one or more characters comprises assigning a different location to each of the one or more characters.

### Example 48

The computer-readable medium of any of examples 45 and 46, the acts further comprising, for each received data packet, displaying an indication, within the display of the first computing device, that the data packet has been received.

### Example 49

The computer-readable medium of any of examples 45 and 46, the acts further comprising: determining, based on the sequence of data packets, a sequence of characters that are displayed respectively at the locations represented respectively by the received data packets; determining, that the determined sequence of characters matches the predetermined authentication code; and sending the message based on determining that the sequence matches the predetermined authorization code.

### Example 50

The computer-readable medium of example 49, the acts further comprising: receiving, from a storage device inserted into a data port of the first computing device, data representing the predetermined authentication code; and using the data representing the predetermined authorization code to determine that the determined sequence of characters matches the predetermined authentication code.

### Example 51

The computer-readable medium of any of examples 34-50, wherein the message authorizing the financial transaction is sent to the second computing device.

### Example 52

The computer-readable medium of example 51, wherein the message is a first message, and wherein sending the first message comprises sending a command, to the second computing device, for the second computing device to send a second message, to a third computing device, authorizing the financial transaction.

### Example 53

The computer-readable medium of example 52, wherein the first message and the second message both include an encrypted authorization code.

### Example 54

The computer-readable medium of any of examples 34-50, wherein the message authorizing the financial transaction is sent to a third computing device.

### Example 55

The computer-readable medium of any of examples 34-54, wherein the computer-readable medium is a non-transitory computer-readable medium.

### Example 56

The computer-readable medium of any of examples 34-55, wherein the acts further comprise: detecting a change in state of the first computing device; and displaying each of the one or more characters in response to detecting the change in state.

### Example 57

The computer-readable medium of example 56, wherein detecting the change in state of the first computing device comprises determining that a communication link has been established between the first computing device and the second computing device.

### Example 58

The computer-readable medium of example 56, wherein detecting the change in state of the first computing device comprises receiving a command, from the second computing device, to display each of the one or more characters.

### Example 59

A computer-readable medium storing instructions that when executed by a processor of a first computing device cause the first computing device to perform acts comprising: receiving input indicating one or more selected locations within a first display of the first computing device, wherein the one or more selected locations within the first display correspond respectively to one or more locations within a second display of a second computing device; sending, to the second computing device, data representing the input; receiving, from the second computing device, a first message indicating a match between (i) one or more characters displayed respectively at the one or more locations within the second display and (ii) a predetermined authentication code; and sending, to a third computing device, a second message authorizing a financial transaction.

### Example 60

The computer-readable medium of example 59, wherein the first display is a touch screen, and wherein receiving the input indicating the one or more selected locations within the first display comprises receiving touch input at the one or more selected locations of the touch screen.

### Example 61

The computer-readable medium of example 60, the acts further comprising: displaying one or more boundaries defining the one or more locations within the touch screen; and wherein receiving the touch input at the one or more selected locations of the touch screen comprises receiving touch input at the one or more locations defined by the one or more boundaries.

### Example 62

The computer-readable medium of any of examples 59-60, wherein the one or more locations within the first display comprise one or more locations arranged in a first grid pattern within the first display, and wherein the one or more locations within the second display comprise one or more locations arranged in a second grid pattern within the second display.

### Example 63

The computer-readable medium of example 62, wherein sending the data representing the input comprises, for each of the one or more selected locations within the first display, sending at least one of (i) a first coordinate and a second coordinate that identify a location within the first grid pattern and (ii) a grid position that identifies the location within the first grid pattern.

### Example 64

The computer-readable medium of example 62, wherein sending the data representing the input comprises, for each of the one or more selected locations within the first display, sending at least one of (i) a first coordinate and a second coordinate that identify a location within the second grid pattern and (ii) a grid position that identifies the location within the second grid pattern.

### Example 65

The computer-readable medium of any of examples 59-64, the acts further comprising: sending, to the second computing device, a sequence of multiple data packets representing multiple respective location selections of the one or more selected locations within the first display; for each sent data packet, receiving, from the second computing device, an indication that the sent data packet was received by the second computing device; and in response to each received indication, displaying an indication that the sent data packet corresponding to the received indication was received by the second computing device.

### Example 66

The computer-readable medium of any of examples 59-65, the acts further comprising: receiving, from the second computing device, a transaction authorization code, wherein sending the second message comprises sending, to the third computing device, the transaction authorization code.

### Example 67

The computer-readable medium of any of examples 59-66, wherein the computer-readable medium is a non-transitory computer-readable medium.

### Example 68

The computer-readable medium of any of examples 59-67, the acts further comprising, prior to receiving the input, sending, to the first computing device, a command to display the one or more characters.

### Example 69

A first computing device comprising: a processor; a display; a communication interface; and a computer-readable medium storing instructions that when executed by the processor cause the first computing device to perform acts comprising: displaying each of one or more characters at a location of one or more locations within the display; receiving, via the communication interface from a second computing device, data indicating at least one selected location of the one or more locations within the display; making a determination, that at least one character of the one or more characters matches a predetermined authentication code, wherein each character of the at least one character is displayed at a location of the at least one selected location within the display; and after making the determination, sending a message authorizing a financial transaction.

### Example 70

The first computing device of example 69, wherein the one or more characters include exactly N characters, wherein the one or more locations include exactly N locations, and wherein N is a positive integer greater than one.

### Example 71

The first computing device of example 69, wherein the one or more characters include more than N characters, wherein the one or more locations include exactly N locations, and wherein N is a positive integer greater than one.

### Example 72

The first computing device of any of examples 69-71, wherein the one or more locations within the display comprise one or more locations arranged in a grid pattern within the display.

### Example 73

The first computing device of example 72, wherein receiving the data indicating the at least one selected location within the display comprises, for each of the at least one selected location, receiving at least one of (i) a first coordinate and a second coordinate that identify a location within the grid pattern and (ii) a grid position that identifies the location within the grid pattern.

### Example 74

The first computing device of any of examples 69-73, wherein the one or more characters include at least one numeral.

### Example 75

The first computing device of any of examples 69-74, wherein the one or more characters include at least one letter.

### Example 76

The first computing device of any of examples 69-75, wherein the one or more characters include multiple characters that are mutually distinct.

### Example 77

The first computing device of any of examples 69-76, wherein the determination is a first determination, the acts further comprising: making a second determination that each of the at least one character is displayed at a location of the selected at least one location within the display; and making the first determination based, at least in part, on the second determination.

### Example 78

The first computing device of any of examples 69-77, the acts further comprising: randomly assigning a location of the one or more locations to each of the one or more characters; and displaying each character of the one or more characters at the location randomly assigned to the character.

### Example 79

The first computing device of any of examples 69-78, wherein the display is a first display, wherein the received data indicating the at least one selected location of the one or more locations within the first display comprises data indicating at least one selected location within a second display of the second computing device, and wherein each location of the at least one selected location within the second display corresponds respectively to a location of the at least one selected location within the first display.

### Example 80

The first computing device of any of examples 69-77 and 79, wherein receiving the data indicating the at least one selected location includes receiving, from the second computing device, a sequence of multiple data packets representing multiple respective location selections of the at least one selected location, and wherein the acts further comprise: prior to receiving each data packet, randomly assigning a location of the one or more locations to each of the one or more characters; and prior to receiving each data packet, displaying each of the one or more characters at the location assigned to each of the one or more characters.

### Example 81

The first computing device of any of examples 69-77 and 79, wherein receiving the data indicating the at least one selected location includes receiving, from the second computing device, a sequence of multiple data packets representing multiple respective location selections of the at least one selected location, and wherein the acts further comprise: prior to receiving any data packet of the sequence, randomly assigning a location of the one or more locations to each of the one or more characters; and displaying each of the one or more characters at the location assigned to each of the one or more characters as each data packet is received.

### Example 82

The first computing device of any of examples 78, 80, and 81, wherein randomly assigning a location of the one or more locations to each of the one or more characters comprises assigning a different location to each of the one or more characters.

### Example 83

The first computing device of any of examples 80 and 81, the acts further comprising, for each received data packet, displaying an indication, within the display of the first computing device, that the data packet has been received.

### Example 84

The first computing device of any of examples 80 and 81, the acts further comprising: determining, based on the sequence of data packets, a sequence of characters that are displayed respectively at the locations represented respectively by the received data packets; determining, that the determined sequence of characters matches the predetermined authentication code; and sending the message based on determining that the sequence matches the predetermined authorization code.

### Example 85

The first computing device of example 84, further comprising a data port, the acts further comprising: receiving, from a storage device inserted into the data port, data representing the predetermined authentication code; and using the data representing the predetermined authorization code to determine that the determined sequence of characters matches the predetermined authentication code.

### Example 86

The first computing device of any of examples 69-85, wherein the message authorizing the financial transaction is sent to the second computing device.

### Example 87

The first computing device of example 86, wherein the message is a first message, and wherein sending the first message comprises sending a command, to the second computing device, for the second computing device to send a second message, to a third computing device, authorizing the financial transaction.

### Example 88

The first computing device of example 87, wherein the first message and the second message both include an encrypted authorization code.

### Example 89

The first computing device of any of examples 69-85, wherein the message authorizing the financial transaction is sent to a third computing device.

### Example 90

The first computing device of any of examples 69-89, wherein the computer-readable medium is a non-transitory computer-readable medium.

### Example 91

The first computing device of any of examples 69-90, further comprising: detecting a change in state of the first computing device; and displaying each of the one or more characters in response to detecting the change in state.

### Example 92

The first computing device of example 91, wherein detecting the change in state of the first computing device comprises determining that a communication link has been established between the first computing device and the second computing device.

### Example 93

The method of example 91, wherein detecting the change in state of the first computing device comprises receiving a command, from the second computing device, to display each of the one or more characters.

### Example 94

A first computing device comprising: a processor; a first display; and a computer-readable medium storing instructions that when executed by the processor cause the first computing device to perform acts comprising: receiving input indicating one or more selected locations within the first display, wherein the one or more selected locations within the first display correspond respectively to one or more locations within a second display of a second computing device; sending, to the second computing device, data representing the input; receiving, from the second computing device, a first message indicating a match between (i) one or more characters displayed respectively at the one or more locations within the second display and (ii) a predetermined authentication code; and sending, to a third computing device, a second message authorizing a financial transaction.

### Example 95

The first computing device of example 94, wherein the first display is a touch screen, and wherein receiving the input indicating the one or more selected locations within the first display comprises receiving touch input at the one or more selected locations of the touch screen.

### Example 96

The first computing device of example 94, the acts further comprising: displaying one or more boundaries defining the one or more locations within the touch screen; and wherein receiving the touch input at the one or more selected locations of the touch screen comprises receiving touch input at the one or more locations defined by the one or more boundaries.

### Example 97

The first computing device of any of examples 94-96, wherein the one or more locations within the first display comprise one or more locations arranged in a first grid pattern within the first display, and wherein the one or more locations within the second display comprise one or more locations arranged in a second grid pattern within the second display.

### Example 98

The first computing device of example 97, wherein sending the data representing the input comprises, for each of the one or more selected locations within the first display, sending at least one of (i) a first coordinate and a second coordinate that identify a location within the first grid pattern and (ii) a grid position that identifies the location within the first grid pattern.

### Example 99

The first computing device of example 97, wherein sending the data representing the input comprises, for each of the one or more selected locations within the first display, sending at least one of (i) a first coordinate and a second coordinate that identify a location within the second grid pattern and (ii) a grid position that identifies the location within the second grid pattern.

### Example 100

The first computing device of any of examples 94-99, the acts further comprising: sending, to the second computing device, a sequence of multiple data packets representing multiple respective location selections of the one or more selected locations within the first display; for each sent data packet, receiving, from the second computing device, an indication that the sent data packet was received by the second computing device; and in response to each received indication, displaying an indication that the sent data packet corresponding to the received indication was received by the second computing device.

### Example 101

The first computing device of any of examples 94-100, the acts further comprising: receiving, from the second computing device, a transaction authorization code, wherein sending the second message comprises sending, to the third computing device, the transaction authorization code.

### Example 102

The first computing device of any of examples 94-101, wherein the computer-readable medium is a non-transitory computer-readable medium.

### Example 103

The first computing device of any of examples 94-102, the acts further comprising, prior to receiving the input, sending, to the first computing device, a command to display the one or more characters.

### V. Conclusion

Example embodiments have been described above. Those skilled in the art will understand that changes and modifications can be made to the described embodiments without departing from the true scope and spirit of the present invention, which is defined by the claims.

This detailed description describes various features and functions of the disclosed systems, devices, and methods with reference to the accompanying figures. In the figures, similar symbols typically identify similar components, unless context dictates otherwise. The illustrative embodiments described in the detailed description, figures, and claims are not meant to be limiting. Other embodiments can be used, and other changes can be made, without departing from the spirit or scope of the subject matter presented herein. It will be readily understood that the aspects of the present disclosure, as generally described herein, and illustrated in the figures, can be arranged, substituted, combined, separated, and designed in a wide variety of different configurations, all of which are explicitly contemplated herein.

With respect to any or all of the flow charts in the figures and as discussed herein, each step, block and/or communication can represent a processing of information and/or a transmission of information in accordance with example embodiments. Alternative embodiments are included within the scope of these example embodiments. In these alternative embodiments, for example, functions described as steps, blocks, transmissions, communications, requests, responses, and/or messages can be executed out of order from that shown or discussed, including in substantially concurrent or in reverse order, depending on the functionality involved. Further, more or fewer steps, blocks and/or functions can be used with any of the flow charts discussed herein, and these flow charts can be combined with one another, in part or in whole.

A step or block that represents a processing of information can correspond to circuitry that can be configured to perform the specific logical functions of a herein-described method or technique. Alternatively or additionally, a step or block that represents a processing of information can correspond to a module, a segment, or a portion of program code (including related data). The program code can include one or more instructions executable by a processor for implementing specific logical functions or actions in the method or technique. The program code and/or related data can be stored on any type of computer-readable medium such as a storage device including a disk or hard drive or other storage media.

The computer-readable medium can include non-transitory computer-readable media such as computer-readable media that stores data for short periods of time like register memory, processor cache, and/or random access memory (RAM). The computer-readable media can include non-transitory computer-readable media that stores program code and/or data for longer periods of time, such as secondary or persistent long term storage, like read only memory (ROM), optical or magnetic disks, and/or compact-disc read only memory (CD-ROM), for example. The computer-readable media can be any other volatile or non-volatile storage systems. A computer-readable medium can be considered a computer-readable storage medium, for example, or a tangible storage device.

Software for use in carrying out the invention can also be in transitory form, for example in the form of signals transmitted over a network such as the Internet. Moreover, a step or block that represents one or more information transmissions can correspond to information transmissions between software and/or hardware modules in the same physical device. However, other information transmissions can be between software modules and/or hardware modules in different physical devices.

While various aspects and embodiments have been disclosed herein, other aspects and embodiments will be apparent to those skilled in the art. The various aspects and embodiments disclosed herein are for purposes of illustration and are not intended to be limiting.

1-24. (canceled)

25. A method comprising:
receiving, by a first computing device comprising a first display, input indicating one or more selected locations within the first display, wherein the one or more selected locations within the first display correspond respectively to one or more locations within a second display of a second computing device;
sending, by the first computing device to the second computing device, data representing the input;
receiving, by the first computing device from the second computing device, a first message indicating a match between (i) one or more characters displayed respectively at the one or more locations within the second display and (ii) a predetermined authentication code; and
sending, by the first computing device to a third computing device, a second message authorizing a financial transaction.

26. The method of claim 25, wherein the first display is a touch screen, and wherein receiving the input indicating the one or more selected locations within the first display comprises receiving touch input at the one or more selected locations of the touch screen.

27. The method of claim 26, further comprising:
displaying one or more boundaries defining the one or more locations within the touch screen; and
wherein receiving the touch input at the one or more selected locations of the touch screen comprises receiving touch input at the one or more locations defined by the one or more boundaries.

28. The method of claim 25, wherein the one or more locations within the first display comprise one or more locations arranged in a first grid pattern within the first display, and wherein the one or more locations within the second display comprise one or more locations arranged in a second grid pattern within the second display.

29. The method of claim 28, wherein sending the data representing the input comprises, for each of the one or more selected locations within the first display, sending at least one of (i) a first coordinate and a second coordinate that identify a location within the first grid pattern and (ii) a grid position that identifies the location within the first grid pattern.

30. The method of claim 28, wherein sending the data representing the input comprises, for each of the one or more selected locations within the first display, sending at least one of (i) a first coordinate and a second coordinate that identify a location within the second grid pattern and (ii) a grid position that identifies the location within the second grid pattern.

31. The method of claim 25, further comprising:
sending, by the first computing device to the second computing device, a sequence of multiple data packets representing multiple respective location selections of the one or more selected locations within the first display;
for each sent data packet, receiving, by the first computing device from the second computing device, an indication that the sent data packet was received by the second computing device; and
in response to each received indication, displaying an indication that the sent data packet corresponding to the received indication was received by the second computing device.

32. The method of claim 25, further comprising:
receiving, by the first computing device from the second computing device, a transaction authorization code,
wherein sending the second message comprises sending, by the first computing device to the third computing device, the transaction authorization code.

33. The method of claim 25, further comprising, prior to receiving the input, sending, to the second computing device, a command to display the one or more characters.

34-58. (canceled)

59. A computer-readable medium storing instructions that when executed by a processor of a first computing device cause the first computing device to perform acts comprising:
receiving input indicating one or more selected locations within a first display of the first computing device, wherein the one or more selected locations within the first display correspond respectively to one or more locations within a second display of a second computing device;
sending, to the second computing device, data representing the input;
receiving, from the second computing device, a first message indicating a match between (i) one or more characters displayed respectively at the one or more locations within the second display and (ii) a predetermined authentication code; and
sending, to a third computing device, a second message authorizing a financial transaction.

60-93. (canceled)

94. A first computing device comprising:
a processor;
a first display; and
a computer-readable medium storing instructions that when executed by the processor cause the first computing device to perform acts comprising:
receiving input indicating one or more selected locations within the first display, wherein the one or more selected locations within the first display correspond respectively to one or more locations within a second display of a second computing device;
sending, to the second computing device, data representing the input;
receiving, from the second computing device, a first message indicating a match between (i) one or more characters displayed respectively at the one or more locations within the second display and (ii) a predetermined authentication code; and
sending, to a third computing device, a second message authorizing a financial transaction.

95. The first computing device of claim 94, wherein the first display is a touch screen, and wherein receiving the input indicating the one or more selected locations within the first display comprises receiving touch input at the one or more selected locations of the touch screen.

96. The first computing device of claim 94, the acts further comprising:
displaying one or more boundaries defining the one or more locations within the touch screen; and
wherein receiving the touch input at the one or more selected locations of the touch screen comprises receiving touch input at the one or more locations defined by the one or more boundaries.

97. The first computing device of claim 94, wherein the one or more locations within the first display comprise one or more locations arranged in a first grid pattern within the first display, and wherein the one or more locations within the second display comprise one or more locations arranged in a second grid pattern within the second display.

98. The first computing device of claim 97, wherein sending the data representing the input comprises, for each of the one or more selected locations within the first display, sending at least one of (i) a first coordinate and a second coordinate that identify a location within the first grid pattern and (ii) a grid position that identifies the location within the first grid pattern.

99. The first computing device of claim 97, wherein sending the data representing the input comprises, for each of the one or more selected locations within the first display, sending at least one of (i) a first coordinate and a second coordinate that identify a location within the second grid pattern and (ii) a grid position that identifies the location within the second grid pattern.

100. The first computing device of claim 94, the acts further comprising:
sending, to the second computing device, a sequence of multiple data packets representing multiple respective location selections of the one or more selected locations within the first display;
for each sent data packet, receiving, from the second computing device, an indication that the sent data packet was received by the second computing device; and
in response to each received indication, displaying an indication that the sent data packet corresponding to the received indication was received by the second computing device.

101. The first computing device of claim 94, the acts further comprising:
receiving, from the second computing device, a transaction authorization code,
wherein sending the second message comprises sending, to the third computing device, the transaction authorization code.

102. The first computing device of claim 94, wherein the computer-readable medium is a non-transitory computer-readable medium.

103. The first computing device of claim 94, the acts further comprising, prior to receiving the input, sending, to the first computing device, a command to display the one or more characters.
